(19) United States
(12) Patent Application Publication
(10) Pub. No.: US 2019/0375967 A1
(43) Pub. Date: Dec. 12, 2019

(54) LOW WATER VAPOR TRANSMISSION RATE (WVTR) ADHESIVE

(71) Applicant: 3M INNOVATIVE PROPERTIES COMPANY, St. Paul, MN (US)

(72) Inventors: Ying Zhang, Woodbury, MN (US); Vasav Sahni, Saint Paul, MN (US); Albert I. Everaerts, Tucson, AZ (US); Jason D. Clapper, Lino Lakes, MN (US); Jianhui Xia, Woodbury, MN (US)

(21) Appl. No.: 16/485,355

(22) PCT Filed: Feb. 14, 2018
(86) PCT No.: PCT/US2018/018122

§ 371 Date: Aug. 12, 2019

Related U.S. Application Data
(60) Provisional application No. 62/459,901, filed on Feb. 16, 2017.
(60) Provisional application No. 62/459,911, filed on Feb. 16, 2017.

(51) Int. Cl. C09J 123/22; C09J 11/06

(52) U.S. Cl. CPC C09J 123/22; C09J 11/06

(57) ABSTRACT

The present invention is an adhesive composition including at least one low molecular weight polyisobutylene polymer having a weight average molecular weight of about 75,000 or lower, at least one high molecular weight polyisobutylene polymer having a weight average molecular weight of about 120,000 or higher, and optionally, at least one tackifier.

### BACKGROUND

Many types of input devices are presently available for performing operations in an electronic system, such as buttons, keys, mice, touch panels, touch screens and the like. Touch screens, in particular, are becoming increasingly popular because of their intuitive appeal and ease of operation. Touch screens can allow a user to perform various functions by touching the touch sensor panel. To make these devices, silver nanowire, metal mesh (e.g., Cu, Ag, Ag halide), indium tin oxide (ITO) alternatives, are increasingly being utilized. The non-ITO based conducting films have low resistance relative to ITO transparent electrodes which have high electrical resistance issues in large sized touch application.

Even with lower resistance and cheaper manufacturing cost, the metal based materials are well known to be susceptible to electrochemical oxidation with an oxidant such as oxygen and moisture. The oxidation and the electro-migration between silver or copper traces when under current flow and in elevated temperature/high humidity environment (i.e. 65 degrees C. and 90% humidity) will cause connectivity issues in the electro-conductive trace. Indeed, metallic migration between traces can cause so-called dendritic growth and bridging between traces, which eventually short the circuit. In contrast, corrosion can disrupt the traces and thus the current passing through them.

Organic Light emitting diodes (OLEDs) are increasingly being utilized in displays and light sources because of their lower power consumption, higher response speed and excellent space utilization. The OLED element is very sensitive to moisture or oxygen. The organic luminescent material easily loses its luminescence once it is exposed to moisture, and the highly reactive cathode with low work function will be easily corroded by moisture and oxygen.

### SUMMARY

A polyolefin-based adhesive with low water vapor transmission rate, low moisture content, low dielectric constant (Dk), and optional UV blocking features, is described.

In one embodiment, the polyolefin based adhesive with low water vapor transmission rate, low moisture content, low Dk, and optional UV blocking properties is an optically clear adhesive (OCA).

Another embodiment of the present disclosure includes an adhesive composition comprising: one or more low molecular weight polyisobutylene polymer(s), one or more high molecular weight polyisobutylene polymer(s) and optionally, a tackifier.

In a further embodiment, the low molecular weight polyisobutylene polymer has a weight average molecular weight of about 75,000 or lower, and the high molecular weight polyisobutylene polymer has a weight average molecular weight of about 120,000 or higher.

In a further embodiment, the composition has a 60° C./5 minute creep compliance or rheological compliance of than 1.5×10⁻⁴.

### BRIEF DESCRIPTION OF THE FIGURE

FIG. 1 is a top view of a sample construction for patterned ITO polyester film resistance change measurement.

This figure is not drawn to scale and is intended merely for illustrative purposes.

### DETAILED DESCRIPTION

To protect the touch sensor and OLED in an electronic device, a low WVTR, low moisture content, and low DK adhesive or OCA is described, which can be directly integrated into an electronic device to protect sensor and display from moisture, temperature, foreign materials or chemical penetration. The adhesive or OCA has a low water vapor transmittance rate (WVTR), low moisture content, low dielectric constant (Dk), and optional ultraviolet (UV) blocking features. Even with low WVTR and low moisture content, the adhesive or OCA retains its optical quality during durability testing, i.e., it retains high visible light transmission and low haze. Since the OCA retains high visible light transmission and low haze, it can advantageously be used in the visible area of the touch sensor panel. Additionally, the OCA described herein provides good compliance, imparts corrosion protection, and provides flow properties to cover the sensor trace, flexible printed circuits (FPC) and any display cover ink step.

In an embodiment, the adhesive or OCA comprises polyisobutylene (PIB) as the base polymer wherein the PIB is a combination of one or more PIB resin(s) having a combined a weight average molecular weight of 75,000 and below (hereafter “low-molecular weight PIB resin”), and a combination of one or more PIB resin(s) having a combined a weight average molecular weight of 120,000 and above (hereafter “high-molecular weight PIB resin”).

PIB resins suitable for use in the adhesive or OCA materials described herein, are generally resins having a polyisobutylene skeleton in the main or a side chain. Fundamentally, such a polyisobutylene resin can be prepared by polymerizing isobutylene alone or as a combination of isobutylene and n-butene, isoprene, or butadiene in the presence of a Lewis acid catalyst such as aluminum chloride or boron trifluoride. Suitable polyisobutylene resins are commercially available under the trade designation VISTANEX (Exxon Chemical Co.), HYCAR (Goodrich Corp.), OPANOL (BASF AG), and JSR BUTYL (Japan Butyl Co., Ltd.).

The low-molecular weight PIB resin has a weight average molecular weight 75,000 g/mol or below. The high-molecular weight PIB resin has a weight average molecular weight 120,000 g/mol or above. Applicants have found that the combination of the low and high-molecular weight PIB resins is particularly advantageous as the combination provides a broad range of desirable characteristics. Low molecular weight PIB facilitates processing during hot melt extruding, by lowering the melt viscosity of the compounded adhesive mixture. In solvent processing, low molecular weight facilitates faster diffusion of solvent during drying, thus enabling thicker coatings. Also, low molecular weight PIB imparts conformability to an OCA which enables ink step coverage, and proper wet-out on different surfaces, which are critical features in OCAs. High molecular weight imparts cohesion to an adhesive system which improves the adhesive forces, shear strength, tensile strength, room temperature and high temperature dimensional stability. These properties are critical for OCAs and differing applications may require broad range of composition to accommodate the particular characteristic for each particular application. The amount of low-molecular weight PIB present in the adhesive or OCA can range between 1-90% by weight and the amount of high-molecular weight PIB present in the adhesive or OCA can range between 1-80% by weight. More than one low molecular weight PIB and more than one high molecular weight can be used.

The adhesive or OCA compositions disclosed herein may optionally include a tackifier. Addition of tackifiers allows the composition to have higher adhesion which can be beneficial for some applications where adhering to different substrates is a critical requirement. The addition of tackifiers increases the Tg of the composition and can reduce its storage modulus at room temperature, thus making it less elastic and more flowable, such as what is required for compliance to an ink step during lamination. However, that same addition of a tackifier can shift the visco-elastic balance too much towards the viscous behavior, such as in those cases where minimal creep and thus less flow is required. The addition of tackifiers is thus optional, and its presence and concentration is dependent on the particular application.

Suitable tackifiers include non-hydrogenated and hydrogenated aliphatic tackifiers, including so-called C5 resins and dicyclopentadienyl resins. Hydrogenated resins are preferred. These tackifiers are typically used between 1 and 70 parts per hundred by weight based on the polyisobutylene components. Because of their low color and environmental stability, these tackifiers are particularly advantageous for OCA type applications. In some embodiments, tackifiers are used between 10 and 60 parts per hundred by weight based on the polyisobutylene components.

Other suitable tackifiers include, organic resins, such as wood-based resins such as a rosin resin, a rosin phenol resin, and a rosin ester resin; hydrogenated rosin-based resins obtained by hydrogenating these rosin-based resins; terpene based resins including a terpene phenol-based resins, and an aromatic modified terpene-based resin; and hydrogenated terpene-based resins obtained by hydrogenating these terpene based resins; and resins derived from petroleum, such as C9-based petroleum resins and their hydrogenated versions (cycloaliphatics), or mixed synthetic resins such as those obtained by copolymerizing C9 fractions and C5 fractions of petroleum resins and their hydrogenated versions. These tackifiers may be less miscible and colored, so they are used where slight haze is acceptable and at lower concentrations so the OCA color is acceptable.

In addition, liquid rheology modifiers, such as plasticizers or oils may also be used. For example mineral oil (Kaydol), napthenic oil (Calsol 5550), paraffinic (Hyprene P100N) etc. The benefit of using a plasticizer/oil in combination with a tackifier is that it allows one to reduce the glass transition temperature of the composition in addition to reducing the storage modulus of the composition. This imparts higher flow characteristics to the composition which is advantageous in applications where conformability to features like ink steps, flex connects etc., is required. In applications requiring defect-free lamination coverage of an ink-step, adhesive compositions with a higher creep compliance are known to provide better ink-step coverage. A creep compliance of greater than 1.5×10⁴ has been found most desirable for optimal lamination coverage on commercial ink-step features.

The adhesive or OCA compositions disclosed herein may further include a UV blocking agent. The UV blocking package includes UV absorbents or combination of UV absorbents and light stabilizers. Examples of suitable UV absorbers include, but are not limited to, benzophenone, benzotriazole, triazines or combination of them. Examples of light stabilizers include, but are not limited to, hindered amine light stabilizers (HALS). The adhesive sheet of the present invention has neutral color and low haze, which is required for the optically clear adhesive. The adhesive sheet of this invention has a sharp UV cut-off, examples of UV cut-off include, but are not limited to, transmittance (% T) less than 1.5% at 380 nm wavelength, 84% at 400 nm wavelength and higher than 96% at 410 nm wavelength and above, which can block UV light or even purple light efficiently, but does not cause too much yellow color.

The adhesive or OCA compositions disclosed herein may further include additional additives such as primary and secondary antioxidants, in-process stabilizers, light stabilizers, processing aids, and elastomeric polymers, nanoscale fillers, transparent fillers, getter/scavenger fillers, desiccants, crosslinkers, pigments, extenders, softeners, and resin stabilizers. These additives may be used singly and in combination of two or more kinds thereof.

In certain embodiments, the pressure-sensitive adhesive compositions containing the PIBs are optically clear. Thus, certain articles can be laminates that include an optically clear substrate (e.g., an optical substrate such as an optical film) and an optically clear adhesive layer of the PIB pressure sensitive adhesive composition adjacent to at least one major surface of the optically clear substrate. The laminates can further include a second substrate permanently or temporarily attached to the pressure-sensitive adhesive layer and with the pressure-sensitive adhesive layer being positioned between the optically clear substrate and the second substrate.

In some example laminates in which an optically clear pressure-sensitive adhesive layer (i.e., the PIB based pressure-sensitive adhesive composition described herein) is positioned between two substrates, at least one of the substrates is an optical film, a display unit, a touch sensor, or a lens. Optical films intentionally enhance, manipulate, control, maintain, transmit, reflect, refract, absorb, retard, or otherwise alter light that impinges upon a surface of the optical film. Optical films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Optical films for the provided laminates can also include retarder plates such as quarter-wave and half-wave phase retardation optical elements. Other optically clear films can include clear plastics (such as polyester, cyclic olefin copolymer, clear polyimide, polycarbonate, or polymethylmethacrylate), anti-splinter films, and electromagnetic interference filters. Some of these films may also be used as substrates for ITO (i.e., indium tin oxide) coating or patterning, such as use those used for the fabrication of touch sensors. The low water uptake and WVTR of the PIB adhesives of this invention provide a stable, low dielectric constant OCA which can be very advantageous for use in touch sensor applications, both to protect the sensor and integrating conductors from the environment and corrosion, and also to minimize electronic noise communication with the sensor.

In some embodiments, laminates that include a PIB pressure-sensitive adhesive as describe herein can be optical elements, or can be used to prepare optical elements. As used herein, the term “optical element” refers to an article that has an optical effect or optical application. The optical elements can be used, for example, in electronic displays (e.g., liquid crystal displays (LCDs), organic light emitting displays (OLEDs), architectural applications, transportation applications, projection applications, photonics applications, and graphics applications. Suitable optical elements include, but are not limited to, glazing (e.g., windows and windshields), screens or displays, polarizing beam splitters, ITO-coated touch sensors such as those using glass or clear plastic substrates, and reflectors.

In addition to various optics-related applications and/or electronic display assembly applications, the PIB pressure-sensitive adhesive compositions can be used in a variety of other applications. For example, an article can be formed by forming a layer (e.g., film) of a pressure-sensitive adhesive composition on a backing or release liner. If a release liner is used, the layer can be transferred to another substrate. The other substrate can be, for example, a component of an electronic display assembly. That is, the layer can be laminated to another substrate. The film is often laminated between a first substrate and a second substrate (i.e., the layer of pressure-sensitive adhesive is positioned between the first substrate and the second substrate).

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

TABLE 1
Materials

| Chemical names | Suppliers |
|---|---|
| 2-EHA: 2-ethylhexyl acrylate | BASF |
| HEA: 2-Hydroxy ethyl acrylate | BASF |
| MEK—methylethylketone | Sigma Aldrich |
| iBOA: Isobornyl Acrylate | San Ester |
| Desmodur N3300 | Bayer |
| Karenz MT PE1 | SHOWA DENKO |
| Vazo 52: 2,2′-Azobis(2,4- | Dupont |
| dimethylvaleronitrile) | |
| Escorez 5300 | Exxon Mobil Chemical |
| BHT: Di-tert-butyl-4-Methylphenol | Sigma Aldrich |
| KBM-403: 3-glycidoxypropyl | Shin-Etsu |
| triethoxysilane | |
| Oppanol B15 | BASF |
| Oppanol B50 | Kuraray |
| Oppanol B80 | Kuraray |
| Oppanol B150 | Arakawa |
| Tinuvin 477 | BASF |
| Tinuvin 928 | BASF |
| Tinuvin 123 | BASF |
| SH 81 PET | SKC |
| Regalite R1090 | Eastman |
| RF 52N release liner | SKC Haas |
| RF 22N release liner | SKC Haas |
| RF 02N release liner | SKC Haas |

### Acrylic Copolymer 1:

A mixture of 2-EHA/iBOA/HEA=55/25/20 (parts by mass) was prepared and diluted with MEK to have a monomer concentration of 50 mass %. Furthermore, Karenz MT PE1 and Vazo-52 were added in a ratio of 0.04% and 0.08 mass % based on monomer components respectively, and the reaction bottle was nitrogen-purged for 10 minutes and sealed. Subsequently, the reaction was allowed to proceed in a constant temperature bath at 55° C. for 20 hours, then we increased the reaction temperature to 65° C. for an additional 4 hrs. As a result, a transparent viscous solution was obtained. The weight average molecular weight of the obtained acrylic copolymer was 456,000 (vs. polystyrene standard by gel permeation chromatography).

### Comparative Example 1

To acrylic copolymer 1, Tinuvin 928, Tinuvin 477, Tinuvin 123, KBM 403 and Desmodur N-3300 were added in the ratios of, 4.2, 0.3, 0.6, 0.1 and 0.4 mass parts per hundred respectively based on the copolymer mass. Then, the prepared adhesive solution was coated on a 50 μm thick release film RF52N and dried in an oven at 70° C. for 30 minutes. The thickness of the OCA after drying was 25 μm. Subsequently, this OCA surface was laminated with a 50 μm-thick release film RF02N and aged at 70° C. oven for 24 hours.

### Comparative Example 2

Oppanol B50/B80/Escorez 5300=25/50/25 (parts by mass) was dissolved with heptane to make homogeneous solution. To this solution, Tinuvin 928, Tinuvin 477, Tinuvin 123 and BHT were added in the ratios of, 4.2, 0.3, 0.6 and 0.06 mass parts per hundred respectively based on dry polymer and resin mass. Then, the prepared solution was coated on a 50 μm-thick release film RF22N and dried in an oven at 70° C. for 30 minutes. The thickness of the OCA after drying was 25 μm. Subsequently, this OCA surface was laminated with a 50 μm-thick release film RF02N. The sample has a 60° C./5 minute rheological, or creep, compliance of 0.48×10⁻⁴.

### Adhesive Example-1

Oppanol B15/B150/Regalite R1090=66.6/16.7/16.7 (parts by mass) was dissolved with heptane to make a homogeneous solution. To this solution, Tinuvin 928, Tinuvin 477, Tinuvin 123 and BHT were added in the ratios of, 4.2, 0.3, 0.6 and 0.06 mass parts per hundred respectively based on dry polymer and resin mass. Then, the prepared solution was coated on a 50 μm-thick release film RF22N and dried in an oven at 70° C. for 30 minutes. The thickness of the OCA after drying was 25 μm. Subsequently, this OCA surface was laminated with a 50 μm thick release film RF02N. The sample has a 60° C./5 minute rheological, or creep, compliance of 1.82×10⁻⁴.

### Testing Method to Determine Cohesive Integrity (Creep Compliance Test)

Samples were evaluated for their creep compliance (J) at 60° C. using a rheological dynamic analyzer (Model DHR-3 Rheometer, which is available from TA Instruments, New Castle, Del., USA) equipped with a Peltier Plate heating fixture. The creep compliance may alternatively be described as rheological compliance. Samples were prepared by coating the polymeric material onto a silicone release liner and drying it at 160° C. in a vacuum oven. The resulting polymeric film was then pressed at 140° C. to a thickness of approximately 1 millimeter (0.039 inches). After allowing to cool under ambient conditions to room temperature, samples were then punched out using an 8 millimeter (0.315 inches) diameter circular die, and adhered onto an 8 millimeter diameter upper parallel plate after removal of the release liner. The plate with polymeric film was positioned over and onto the Peltier Plate in the rheometer with the exposed polymeric sample surface contacting the Peltier Plate, and the polymeric film compressed until the edges of the sample were uniform with the edges of the top plate. The temperature was then equilibrated at the test temperatures for 2 minutes at a nominal axial force of 0 grams +/−15 grams. After two minutes, the axial force controller was disabled in order to maintain a fixed gap during the remainder of the test. A stress of 8,000 Pascals was applied to the sample for 300 seconds, and the creep compliance (J) at 287 seconds was recorded.

### Testing Method for Determination of the Water Vapor Transmission Rate (WVTR)

WVTR is conducted by modified Japanese Industrial Standard (JIS), which is a dish method. The materials used in this testing include moisture absorbent Drierite, nanoporous polyolefin TIPS film (as described in U.S. Pat. No. 5,238,623) and 3M green tape #8403. Dry 1 pound of Drierite in 120° C. oven overnight. Remove one liner from the optically clear adhesive and laminate it to a very high WVTR support film (so the adhesive does not sag during the test), such as the TIPS film. Cut the OCA/TIPS so that that it is larger than the jar opening and remove the second liner. Tape the OCA/TIPS construction to the glass jar with the OCA facing the jar rim. Use 3M green tape #8403 to wrap around the overhanging OCA/TIPS around the jar and make a tight seal. Weigh the jar/desiccant/OCA/TIPS/#8403 tape/label and record the weight W₀ in grams, to two decimal places. Place the sample that was just weighed into 65° C./90% RH chamber for 24 hours. Remove the samples after 24 hours in 65° C./90% RH chamber and weigh the jar/desiccant/OCA/TIPS/#8403 tape/label and record the weight W₁ in grams, to two decimal places. Determine the water take up W₁−W₀ in grams. Determine the area of the jar opening and calculate WVTR measured in grams/m².day. The results are summarized in Table 2.

TABLE 2
Water Vapor transmission rate (WVTR, gram/m²/day)

| | WVTR (24 hours @ |
|---|---|
| OCAs | 65° C./90% RH) |
| Comparative example-1 | 3792 |
| Adhesive example-1 | 80 |

### Moisture Content Measurement by Karl-Fisher Titration

Karl-Fischer titration is a common method for moisture content measurement with high accuracy and precision. A crucible with a known weight sample is introduced to a 150° C. environment to evaporate the moisture within the materials and followed by the titration to identify the moisture content percentage in those materials. The testing results are summarized in Table 3.

TABLE 3
Moisture content (%) by Karl-Fischer titration

| | Moisture absorption (%) vs exposure time | | | |
|---|---|---|---|---|
| | at 65° C./90% RH condition | | | |
| OCAs | 0 day | Day 1 | Day 2 | Day 11 |
| Comparative example-1 | 0.46 | 2.15 | 2.25 | 2.23 |
| Adhesive example-1 | Not | Not | Not | Not |
| | detected | detected | detected | detected |

### ITO Compatibility Testing

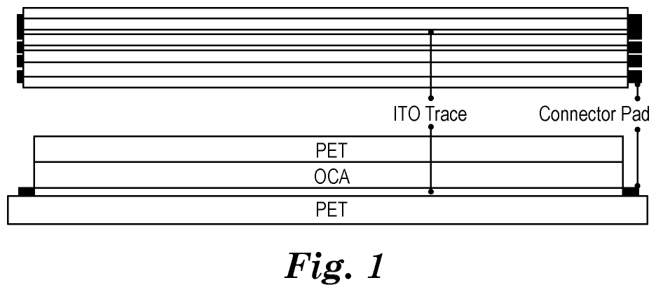

Remove clear liners and laminate OCA samples between 2 mil SH81 polyester (PET, from SKC Films) and indium tin oxide (ITO) patterned PET. Then the ITO patterned PET was taped to glass for support and each test strip contained six circuits as shown in FIG. 1. Measure the resistance (in kOhm) for each circuit with EXTECH Multimeter 380198 and average them as the initial resistance R₀ without environmental exposure. Then the samples were placed in a 65° C./90% RH environmental chamber and measured after t hours environmental exposure Rₜ. The percent resistance change vs. environmental exposure time was calculated as follows: % resistance change=100*(Rₜ−R₀)/R₀, where R₀ is the initial resistance without environmental exposure, Rₜ is the resistance after t hours environmental exposure. The testing results are summarized in Table 4.

TABLE 4
ITO compatibility under heat soak condition

| Time at 65° C./90% RH | % Change in Resistance | |
|---|---|---|
| (Hours) | Control (ITO alone) | Adhesive example-1 |
| 0 | 0.0% | 0.0% |
| 100 | −0.9% | −1.0% |
| 200 | 0.7% | 0.0% |
| 300 | 1.8% | 0.5% |
| 500 | 5.8% | 2.4% |
| 800 | 8.4% | 4.2% |

### Ink Step Coverage and Durability Testing

An OCA sample was hand laminated to 10 μm thick ink step printed glass (i.e. 40% of the 25 micron adhesive thickness), then autoclaved at 60° C. and pressure 6 kg/cm² for 15 minutes. The OCA overlap with the ink step was about 0.2 to 0.5 mm. Then, the second release liner was removed from the OCA and a 2 mil SH 81 PET was hand-laminated, and the sample was ran through a 40 PSI pressurized rubber roller laminator. The sample was then autoclaved again at condition of 60° C. and pressure 6 kg/cm² for 15 minutes. Then the samples were conditioned in an environmental chamber for durability testing. After certain time interval, check for bubbles or delamination. The results are summarized in Table 5, where “good” means that no bubbles or delamination was observed. The tabled indication of “Not good” means that bubbles, delamination, or both were observed.

In applications requiring defect-free lamination coverage of an ink-step, adhesive compositions with a higher creep compliance are known to provide better ink-step coverage. A creep compliance of greater than 1.5×10⁴ has been found most desirable for optimal lamination coverage on commercial ink-step features.

TABLE 5
Ink step coverage lamination and durability testing results

| | Before | After | Environmental | | | | | |
|---|---|---|---|---|---|---|---|---|
| Sample ID | autoclave | autoclave | conditions | 100 hrs | 200 hrs | 300 hrs | 500 hrs | 800 hrs |
| Comparative | Not Good | Not Good | 65° C./90% RH | NA | | | | |
| Example-2 | Not Good | Not Good | 85 C./85% RH | NA | | | | |
| | Not Good | Not Good | 85 C. | NA | | | | |
| Adhesive | good | good | 65 C./90% RH | No | No | No | No | No |
| Example-1 | | | | change | change | change | change | change |
| | good | good | 85 C./85% RH | No | No | No | No | No |
| | | | | change | change | change | change | change |
| | good | good | 85 C. | No | No | No | No | No |
| | | | | change | change | change | change | change |

### Method for Haze Measurement

Haze was measured according to ASTM D 1003-92. The results for adhesive-1 are summarized in Table 6.

TABLE 6
Optics under high temperature and high humidity condition

| | Adhesive Example-1 | | |
|---|---|---|---|
| | | 300 Hour at | 500 Hour at |
| Optics | Ambient | 65° C./90% RH | 65° C./90% RH |
| Transmitted L* | 96.8 | 96.92 | 96.76 |
| Transmitted a* | −0.06 | −0.08 | −0.065 |
| Transmitted b* | 0.31 | 0.375 | 0.355 |
| Transmitted x | 0.3143 | 0.3143 | 0.3145 |
| Transmitted y | 0.3316 | 0.3317 | 0.3317 |
| Haze (%) | 0.285 | 0.185 | 0.18 |

Test specimens—Clean the LCD glass three times with solvents and completely dry it with Kimwipes (available from KimTech). Cut each test specimen to a size large enough to cover the entrance port of the sphere. Remove the clear liner and laminate the OCA onto LCD glass with four passes of a small rubber hand roller. The sample should be free of visible distinct internal voids, particles, scratches, and blemishes. Then put the testing samples in a 65° C./90% RH testing chamber, and after a certain time interval, remove the other clear liner and measure the haze according to ASTM D 1003-92 against the background of LCD glass with UltraScan Pro (Hunterlab).

### Method for Color Measurement:

Color was measured according to ASTM-E1164-07/CIELAB. The results for adhesive-1 are summarized in Table 6 (above).

Test specimens—Clean the LCD glass three times with solvents and completely dry it with Kimwipes. Cut each test specimen to a size large enough to cover the entrance port of the colorimeter port. Remove the clear liner and laminate the OCA onto LCD glass with four passes of a small rubber hand roller. The sample should be free of visible distinct internal voids, particles, scratches, and blemishes. Then put the testing samples in 65° C./90% RH testing chamber, and after a certain time interval, remove the other clear liner and measure the color according to ASTM-E1164-07/CIELAB against the background of LCD glass with UltraScan Pro (Hunterlab).

### Method for Color and Haze Measurement Under UV Aging Condition:

Color was measured according to ASTM-E1164-07/CIELAB and haze was measured according to ASTM D 1003-92. The results for adhesive-1 are summarized in Table 7.

TABLE 7
Optics under UV weathering condition

| | Adhesive Example-1 | | |
|---|---|---|---|
| | | 300 Hour at | 500 Hour at |
| Optics | Ambient | 65° C./90% RH | 65° C./90% RH |
| Transmitted L* | 96.45 | 96.16 | 96.13 |
| Transmitted a* | −0.5625 | −0.5265 | −0.5265 |
| Transmitted b* | 0.6215 | 0.775 | 0.813 |
| Transmitted x | 0.3141 | 0.3144 | 0.3145 |
| Transmitted y | 0.3325 | 0.3327 | 0.3328 |
| Haze (%) | 0.1 | 0.13 | 0.1 |

Test specimens—Clean the float glass three times with solvents and completely dry it with Kimwipes. Cut each test specimen to a size large enough to cover the entrance port of the sphere. Remove the clear liner and laminate the OCA onto float glass with four passes of a small rubber hand roller. The sample should be free of visible distinct internal voids, particles, scratches, and blemishes. Then put the testing samples in UV aging testing chamber, and after a certain time interval, remove the other clear liner and measure the color and haze. The UV exposure condition parameters are: full simulated solar spectrum with an irradiance of 1.2 W/m² at 340 nm, 55° C. black panel temperature, 30° C. air temperature, 30% relative humidity.

### Method for Durability and Anti-Whitening:

Remove the clear liner from a 2 inch by 3 inch adhesive strip and attach it on a 2 mil polyester film (PET). Secure the transfer tape with four passes of a small rubber hand roller, making sure no air bubbles are entrapped. Remove the second liner from the adhesive and laminate the adhesive strip onto a 2 inch by 3 inch LCD glass or a 2 mil polyester film (PET). Secure the transfer tape with four passes of a small rubber hand roller, making sure no air bubbles are entrapped. Then put the testing samples in 65° C./90% RH testing chamber, after certain time interval, check the appearance. For durability, check if there are bubbles are generated. For anti-whitening, check if any laminate whitening disappeared in 24 hours after coming out of the chamber and returning to ambient condition. The results for adhesive-1 are summarized in Table 8.

TABLE 8
Durability under 65° C./90% RH condition

| | | Time of environmental exposure | | | |
|---|---|---|---|---|---|
| Sample ID | Construction | 100 hrs | 300 hrs | 500 hrs | 800 hrs |
| Comparative | PET/PET | No change | No change | No change | No change |
| Example-2 | PET/Glass | No change | No change | No change | No change |
| | Glass/Glass | Bubbles | Bubbles | Bubbles | Bubbles |
| Adhesive | PET/PET | No change | No change | No change | No change |
| Example-1 | PET/Glass | No change | No change | No change | No change |
| | Glass/Glass | No change | No change | No change | No change |

### Dielectric Constant (Dk) and Dielectric Constant Stability Measurement Method:

Raw samples should be prepared to physically fit into the environmental chamber and capacitance measurement apparatus. One liner should be removed before putting the samples into heat soak (HS) chamber. The thickness of the sample during HS exposure is 150 μm and the exposure condition is 65° C. at 90% relative humidity. The sample(s) should be soaked in the environmental condition specified time such as 0, 72, 168, 336 and 504 hrs. After the soak time, the sample(s) should be taken out of chamber and allowed to rest 24 hours at room temperature and humidity conditions, namely, 25° C. and 40-45% RH. Prior to Dk measurement, laminate two 150 μm pieces together. Then dielectric constant measurements should be performed on the samples. The measurement equipment can be located in standard working room conditions. The dielectric constant and electrical dissipation factor (tan delta) were measured using the broadband Novocontrol Dielectric Spectrometer per ASTM D150. The testing results are summarized in Table 9.

TABLE 9
Dielectric constant (Dk) and Dk stability under heat soak condition

| | Dielectric constant (Dk) and Dk | | |
|---|---|---|---|
| Time under 65° C./ | stability under 65° C./90% RH | | |
| 90% RH | at different frequency (KHz) | | |
| (hours) | 10 | 100 | 300 |
| 0 | 2.30 | 2.31 | 2.31 |
| 72 | 2.24 | 2.24 | 2.24 |
| 168 | 2.24 | 2.24 | 2.24 |
| 336 | 2.23 | 2.22 | 2.22 |
| 504 | 2.21 | 2.20 | 2.20 |

Although the present invention has been described with reference to preferred embodiments, workers skilled in the art will recognize that changes may be made in form and detail without departing from the spirit and scope of the invention.

1. An adhesive composition comprising:
at least one low molecular weight polyisobutylene polymer having a weight average molecular weight of about 75,000 or lower;
at least one high molecular weight polyisobutylene polymer having a weight average molecular weight of about 120,000 or higher; and
optionally, at least one tackifier.

2. An adhesive composition for use in electronic device comprising:
at least one low molecular weight polyisobutylene polymer;
at least one high molecular weight polyisobutylene polymer; and
optionally at least one tackifier,
wherein the composition has a 60° C./5 minute creep compliance greater than 1.5×10−4.

3. The adhesive composition of claim 1, wherein the weight percent of components is: 1-90% low molecular weight polyisobutylene, 1-80% high molecular weight polyisobutylene, and 1-60% tackifier.

4. The adhesive composition of claim 1, wherein the adhesive composition is an optically clear adhesive composition.

5. An adhesive composition of claim 1, wherein the tackifier is non-hydrogenated or hydrogenated aliphatic hydrocarbon tackifier.

6. The adhesive composition of claim 1, wherein the composition further contains a UV blocking agent.

7. The adhesive composition of claim 1, wherein the thickness of the adhesive is 0.001-1 mm.

8. The adhesive composition of claim 1, wherein the composition is not crosslinked.

9. The adhesive composition of claim 1, wherein the composition is coated on a substrate.

10. The adhesive composition of claim 1, wherein the composition is positioned between two substrates.

11. The adhesive composition of claim 9, wherein one or more of the substrates is a release liner.

12. The adhesive composition of claim 9, wherein one or more of the substrates is an optical film, a display unit, a touch sensor, or a lens.
